(19) United States
(12) Patent Application Publication
(10) Pub. No.: US 2023/0040925 A1
(43) Pub. Date: Feb. 9, 2023

(54) REFLECTIVE FPM USING A PARABOLIC MIRROR

(71) Applicant: KOREA RESEARCH INSTITUTE OF STANDARD AND SCIENCE, Daejeon (KR)

(72) Inventors: Hee-kyung Ahn, Daejeon (KR); Hwi-hyeong Lee, Daegu (KR)

(73) Assignee: Korean Research Institute of Standard and Science, Daejeon (KR)

(21) Appl. No.: 17/790,434

(22) PCT Filed: Jul. 21, 2020
(86) PCT No.: PCT/KR2020/009568

§ 371 Date: Jun. 30, 2022

(30) Foreign Application Priority Data
Feb. 19, 2020 (KR) 10-2020-0020510

(51) Int. Cl. G02B 21/36; G02B 21/06

(52) U.S. Cl. CPC G02B 21/361; G02B 21/367; G02B 21/06

(57) ABSTRACT

The present disclosure relates to a reflective FPM using a parabolic mirror, and particularly to a reflective FPM using a parabolic mirror including: a first illuminator having a first panel that is provided with numerous LED light sources and composed of a first LED array irradiating a plurality of first LED beams to a measurement object sequentially at different angles through an objective lens; a second illuminator having a second panel that is provided with numerous LED light sources and composed of a second LED array irradiating a plurality of second LED beams to the measurement object sequentially at different angles, following irradiation from the first illuminator; a parabolic mirror reflecting each of second beams generated from the second illuminator, allowing being incident on the measurement object; a lens configured to collect a beam from the measurement object to which the first and second LED beams were irradiated; and a photodetector receiving light from the lens and acquires images for each of a plurality of first and second beams.

### CROSS-REFERENCE TO RELATED APPLICATIONS

This application is a national phase of PCT/KR2020/009568, filed Jul. 21, 2020, and claims priority to Korean Patent Application No. 10-2020-0020510, filed Feb. 19, 2020, the entire contents of both of which are hereby incorporated by reference.

### BACKGROUND

### Technical Field

The present disclosure relates to a reflective FPM using a parabolic mirror. More particularly, in order to overcome limitations of prior reflective FPM, the present disclosure relates to a reflective FPM using a parabolic mirror, which increases a signal-to-noise ratio of acquired images and further improves resolution. This is due to that a normal beam of each LED light source is irradiated to a measurement object by using a planar LED array panel and a parabolic mirror.

### Related Art

Fourier Ptychographic Microscopy (FPM) is a phase revival method developed by Gouan Zheng in 2013, allowing calculating phase without using a reference beam differently from an existing digital holographic microscopy.

Since this FPM allows phase calculation without any reference beam, a compact system can be achieved. Further, since no division in signal beam/reference beam is made, this is advantageously strong against vibrations.

Further, the existing digital holographic microscopy has small field of view (FOV) and depth of focus (DOF) when using an objective lens with high numerical aperture (NA) to achieve high resolution. On the other hand, since the FPM replaces a condenser lens with an LED array, allowing high irradiation angle and thus achieving high resolution with an objective lens with low NA, this advantageously has large FOV and DOF. Further, since the LED array achieves high irradiation angle, this needs no mechanical driving part.

FIG. 1 shows a schematic view of a transmissive FPM system 1, and FIG. 2 shows a spectrum of a measurement object. As shown in FIG. 1, the transmissive FPM system 1 includes an LED array 10 composed of numerous LED light sources 11 that irradiate LED beams to a measurement object 2 at different angles, an objective lens 20 that forms image of LED beams that transmitted the measurement object 2, a condenser lens 30, a photodetector 40 acquiring an image of the LED beams that were irradiated to the measurement object 2.

N beams of different irradiation angles are sequentially irradiated to the measurement object 2 using the LED array 10 composed of N LED light sources 11 and N images are stored in the photodetector 40.

Further, an analysis unit performs FFT (Fast Fourier Transform) of the N images. As shown in FIG. 2 (◯ represents a spectrum of a signal that was focused by an object lens through a beam irradiated from one LED), phase is calculated by stitching while positioning the FFTs of the N images at respective corresponding positions of θx and θy in a spectral domain.

The transmissive FPM is employed for the measurement of transmissive specimens such as a bio-specimen, etc., many studies therefor are in progress. On the other hand, in a case of a reflective FPM, even though there are many demands for the measurement of opaque industrial specimens, a study therefor is slow in progress due to difficulties in setup.

FIG. 3 shows a perspective view of a prior transmissive FPM system. FIG. 4 shows a magnified view of a dark field LED array panel part of FIG. 3, and FIG. 5 shows a photograph of a dark field LED array panel.

As shown in FIGS. 3, 4 and 5, there is a problem of signal-to-noise ratio (SNR) reduction resulting from using of a planar LED illuminator. That is, in a case of an LED light source far from a measurement object S, when the intensity of light that reaches the measurement object becomes weak, this causes a low SNR and thus it is failed to obtain a high spatial frequency signal. Thus, there is a problem of low resolution.

### SUMMARY

### Technical Problem

Therefore, the present disclosure is contrived to solve conventional problems as described above. According to an embodiment of the present disclosure, aimed is to provide a reflective FPM using a parabolic mirror which allows individual LED light sources well focused on a measurement object by using a parabolic mirror in a dark field illuminator and thus increases a SNR and achieves high resolution.

Meanwhile, technical problems to be achieved by the present disclosure are not limited to the aforementioned technical problems, and other not-mentioned technical problems may be clearly understood by ordinary skilled person in the art to which the present disclosure pertains from the description below.

### Technical Solution

The present disclosure aims to achieve a reflective FPM using a parabolic mirror including: a first illuminator having a first panel that is provided with numerous LED light sources and composed of a first LED array irradiating a plurality of first LED beams to a measurement object sequentially at different angles through an objective lens; a second illuminator having a second panel that is provided with numerous LED light sources and composed of a second LED array irradiating a plurality of second LED beams to the measurement object sequentially at different angles, following irradiation from the first illuminator; a parabolic mirror reflecting each of second beams generated from the second illuminator, allowing being incident on the measurement object; a lens configured to collect a beam from the measurement object to which the first and second LED beams were irradiated; and a photodetector receiving light from the lens and acquires images for each of a plurality of first and second beams.

Further, the reflective FPM using a parabolic mirror may be characterized in that the first panel is a plate shape, the LED array is a ring shape, arranged at a center point of the first panel and spaced apart from each other at a predetermined distance in a circumferential direction with reference of the center point of the first panel, and the first ring-shaped LED array is arranged in plural numbers, spaced at a certain distance in a radius direction.

Further, the reflective FPM using a parabolic mirror may be characterized in that the second panel is a ring shape with a central hole, the second LED array is a ring shape, spaced from each other at a predetermined distance in a circumferential direction with reference of a center point of the second panel, and the second ring-shaped LED array is arranged in plural numbers, spaced at a certain distance in a radius direction.

Further, the reflective FPM using a parabolic mirror may be characterized by further including an LED control portion controls that the first LED light source positioned at the center point of the first panel irradiates a beam, and then starting with the light sources on the first LED array having a smaller radius, the light sources irradiate beams sequentially, followed by controlling that starting with the light sources on the second LED array having a smaller radius, the light sources irradiate beams sequentially, and the photodetector may be characterized by acquiring images for the respective beams.

Further, the reflective FPM using a parabolic mirror may be characterized by further including an analysis unit that calculates a synthetic image having phase information of the measurement object by placing each of the images in a spectral domain and stitching.

Further, the reflective FPM using a parabolic mirror may be characterized in that the first beam is irradiated from the first illuminator, passes through an optical system and reflected by a beam splitter, and then is incident on the measurement object through an objective lens.

### Advantageous Effects

According to a reflective FPM using a parabolic mirror in accordance with the present disclosure, it is capable of focusing individual LED light sources on a measurement object well by using a parabolic mirror in a dark field illuminator and thus increases a SNR and achieves high resolution.

Meanwhile, advantageous effects to be obtained by the present disclosure are not limited to the aforementioned effects, and other not-mentioned advantageous effects may be clearly understood by ordinary skilled person in the art to which the present disclosure pertains from the description below.

### BRIEF DESCRIPTION OF THE DRAWINGS

The accompanying drawings of this specification exemplify a preferred embodiment of the present disclosure, and helps more clearly understanding the spirit of the present disclosure along with the following detailed description. Thus, it will be understood that the present disclosure is not limited to only contents illustrated in the accompanying drawings:

FIG. 1 shows a schematic view of a transmissive FPM system.

FIG. 2 shows a spectrum of a measurement object.

FIG. 3 shows a schematic view of a prior transmissive FPM system.

FIG. 4 shows a magnified view of a dark-field LED array panel part of FIG. 3.

FIG. 5 shows a photograph of the dark field LED array panel.

FIG. 6 shows a schematic view of a reflective FPM using a parabolic mirror according to an embodiment of the present invention.

FIG. 7 shows a schematic view of a reflective FPM using a parabolic mirror when a beam is irradiated from a bright field illuminator according to an embodiment of the present disclosure.

FIG. 8 shows a schematic view of a reflective FPM using a parabolic mirror when a beam is irradiated from a dark field illuminator according to an embodiment of the present disclosure.

FIG. 9 shows a plan view of an LED panel of a bright field illuminator according to an embodiment of the present disclosure.

FIG. 10 shows a schematic view of a measurement object, a dark field illuminator, a parabolic mirror and an objective lens according to an embodiment of the present disclosure.

FIG. 11 shows a plan view of an LED panel of a dark field illuminator according to an embodiment of the present disclosure.

FIG. 12 shows a photograph of an LED panel of a dark field illuminator according to an embodiment of the present disclosure.

FIG. 13 shows a photograph of a parabolic mirror according to an embodiment of the present disclosure.

FIG. 14 shows a spectral domain of a measurement object measured according to an embodiment of the present disclosure.

FIG. 15 shows a high resolution image reconstructed at 200 μm of a scale bar, measured according to a test example of the present disclosure.

FIG. 16 shows a magnified view of element 1 in group 11 of FIG. 15, at 10 μm of a scale bar.

FIG. 17 shows a magnified view of element 1 in group 11 when a normal beam is irradiated, at 10 μm of a scale bar.

FIG. 18 shows an intensity profile in element 1 in group 11 of FIG. 16.

FIG. 19 shows a synthetic spectrum by FPM at a log scale measured according to a test example of the present disclosure.

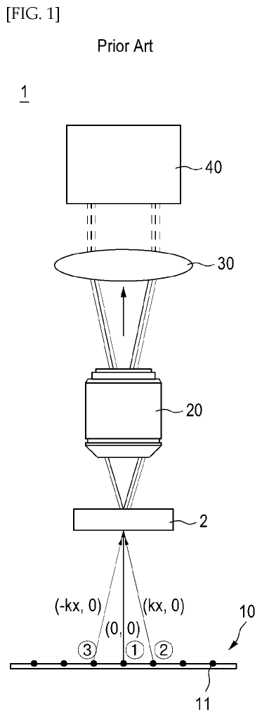

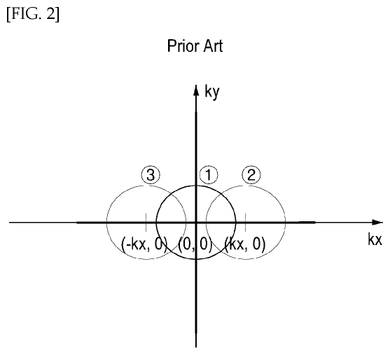

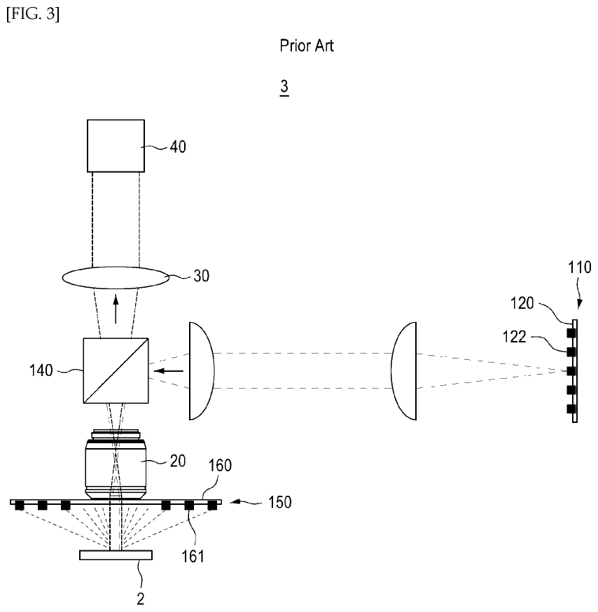

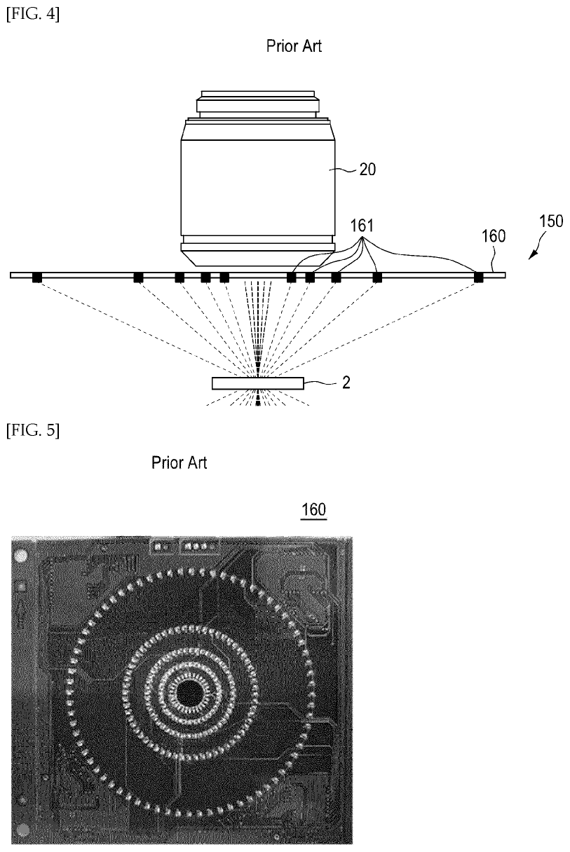

### REFERENCE NUMBERS

1: Prior transmissive FPM
2: Measurement object
3: Prior reflective FPM
10: LED array
11: LED light source
20: Objective lens
30: Condenser lens
40: Photodetector
100: Reflective FPM using a parabolic mirror
110: A first illuminator (bright field illuminator)
120: A first panel (Bright field panel)
121: A first LED array (bright field LED array)
122: A first LED light source (bright field LED light source)
130: An optical system
131: A first lens
132: A field stop
133: A second lens
140: A beam splitter
150: A second illuminator (dark field illuminator)
160: A second panel (dark field panel)
161: A second LED array (dark field LED array)
162: A second LED light source (dark field LED light source)
170: Central hole
180: Parabolic mirror

### DETAILED DESCRIPTION

### Best Mode

Hereinafter, described is the configuration and function of a reflective FPM using a parabolic mirror according to an embodiment of the present disclosure.

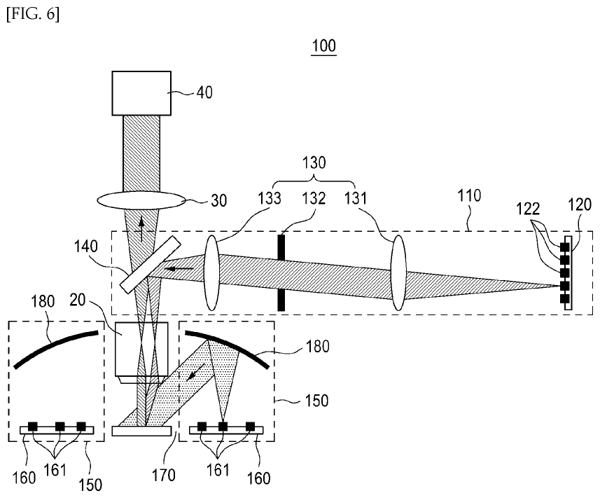

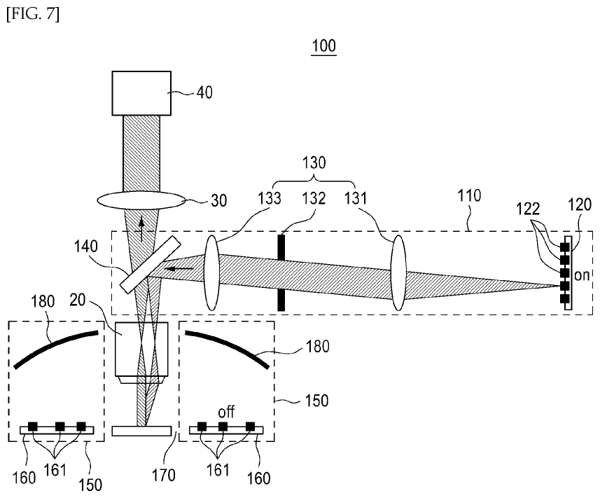

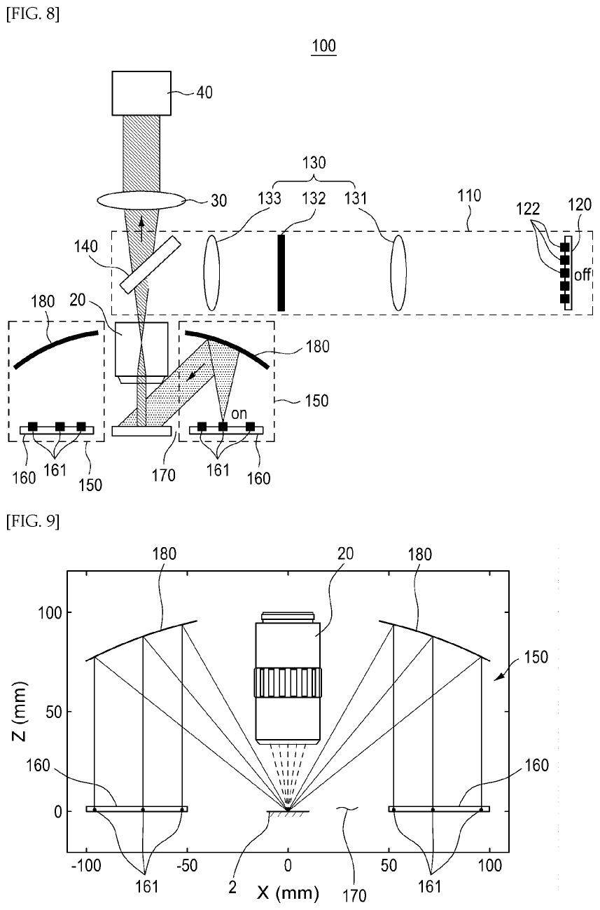

Firstly, FIG. 6 shows a schematic view of a reflective FPM using a parabolic mirror 100 according to an embodiment of the present invention. Further, FIG. 7 a schematic view of the reflective FPM using a parabolic mirror 100 when a beam is irradiated from a bright field illuminator according to an embodiment of the present disclosure. Further, FIG. 8 shows a schematic view of the reflective FPM using a parabolic mirror 100 when a beam is irradiated from a dark field illuminator according to an embodiment of the present disclosure.

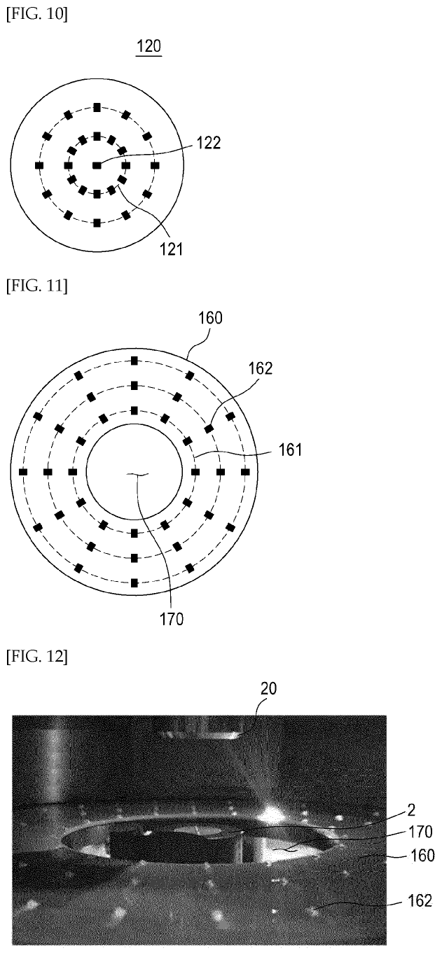

Further, FIG. 9 shows a plan view of an LED panel of a bright field illuminator according to an embodiment of the present disclosure. Further, FIG. 10 shows a schematic view of a measurement object, a dark field illuminator, a parabolic mirror and an objective lens according to an embodiment of the present disclosure.

FIG. 11 shows a plan view of an LED panel of a dark field illuminator according to an embodiment of the present disclosure, and FIG. 12 shows a photograph of an LED panel of a dark field illuminator according to an embodiment of the present disclosure.

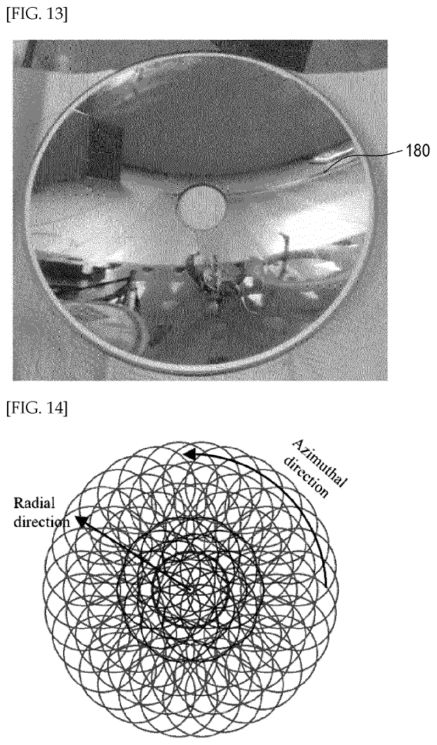

FIG. 13 shows a photograph of a parabolic mirror according to an embodiment of the present disclosure.

Further, FIG. 14 shows a spectral domain of a measurement object measured according to an embodiment of the present disclosure.

As shown in FIGS. 6 to 8, it is seen that, in general, the reflective FPM using a parabolic mirror 100 includes a first illuminator 110 corresponding to a bright field illuminator, an objective lens 20, a second illuminator 150 corresponding to a dark field illuminator, a condenser lens 30, etc.

The first illuminator 110 includes a first panel 120, an optical system 130 and a beam splitter 140, wherein the first panel 120 includes a plurality of first LED arrays 121 that are arranged on the first panel (120) and have numerous first LED light sources 122.

As shown in FIG. 10, it is seen that the first panel 120 is a plate shape. The first LED array 121 is a ring shape, arranged at a center point of the first panel 120 and spaced apart from each other at a predetermined distance in a circumferential direction with reference of the center point of the first panel, and the first ring-shaped LED array 121 is arranged in plural numbers, spaced at a certain distance in a radius direction.

Thus, through an LED control portion, a beam is irradiated sequentially from the first LED light source 122 positioned at the center point of the first panel 120 and then beams are irradiated from the light sources 122 on the first LED array 121 having a small radius.

A first beam irradiated from the first illuminator 110 passes through the optical system 130 formed with a first lens 131, a field stop 132 and a second lens 133 and then reflected by a beam splitter 140. This, as shown in FIGS. 6 and 7, passes the objective lens 20 and reflected on the measurement object 2 to form an image on a back focal plane of the objective lens 20. A beam for imaging pass through the beam splitter 140 and the condenser lens 30 in order and then is detected by the photodetector 40.

The photodetector 40 receives light from the condenser lens and acquires images for each of a plurality of the first beams.

Further, sequentially mad is irradiation from all of the first LED light sources 122 that are arranged in the first panel 120 to acquire an image, and then a second illuminator 150 is driven.

As shown in FIG. 9, the second illuminator 150 is a dark field illuminator, which reflects a second beam by a parabolic mirror 180 without passing thorough the objective lens 20, allowing being incident on the measurement object 2.

According to an embodiment of the present disclosure, even though a light source corresponds to the second LED light source 162 that is far from the measurement object 2, application of the parabolic mirror 180 makes intensity of light reaching the measurement object 2 uniform, thus allowing increasing a SNR and achieving high resolution as compared to the prior reflective FPM 3.

The second illuminator 150 includes a second panel 160 and the parabolic mirror 180. The second panel 160 is provided with a plurality of the second LED light sources 162 and formed with a plurality of second LED arrays 161 that irradiate a plurality of second LED beams to the measurement object 2 sequentially at different angles, after irradiation by the first illuminator 110.

As shown in FIGS. 11 and 12, the second panel 160 is formed in a planar ring shape on which a centric hole 170 is formed. The measurement object is positioned on the centric hole 170, as shown in FIG. 9.

Further, the second LED array 161 is a ring shape, spaced from each other at a predetermined distance in a circumferential direction with reference of a center point of the second panel 160 and this second ring-shaped LED array 161 is arranged in plural numbers, spaced at a certain distance in a radius direction.

Thus, an LED control portion controls that the light sources of the first illuminator 110 irradiate beams sequentially, and then starting with the light sources on the second LED array 161 having a smaller radius, the light sources irradiate beams sequentially.

Further, images by the respective light sources are detected in the photodetector.

That is, the images for the respective LED light sources of the first illuminator 110 and the second illuminator 150 are acquired. Further, as shown in FIG. 14, each of the images is positioned in a spectral domain.

Further, this undergoes stitching and thus a synthetic image having phase information is calculated. That is, the image undergoes IFT (Inversion Fourier Transform) to acquire a spectrum and then the phase information is acquired by converging phase through an overlapping region to generate the synthetic image having phase information.

### Description of Embodiments

Hereinafter, described is a test result of a reflective FPM using a parabolic mirror according to the aforementioned embodiment of the present disclosure.

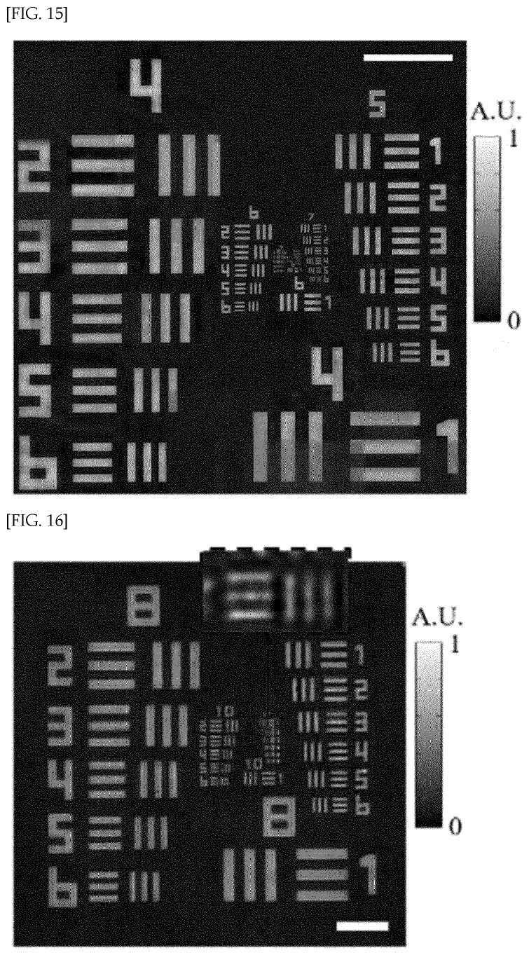

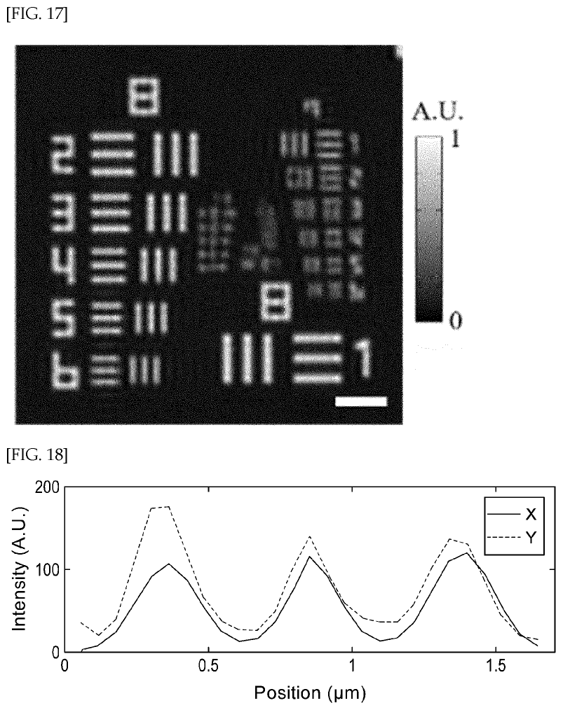

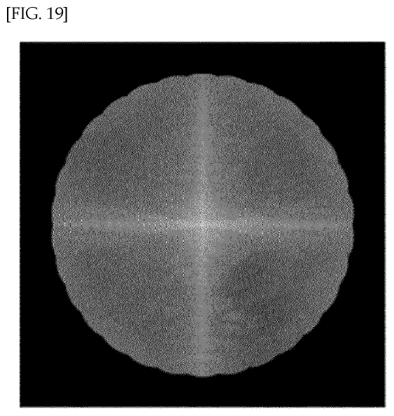

FIG. 15 shows a high resolution image reconstructed at 200 μm of a scale bar, measured according to a test example of the present disclosure. FIG. 16 shows a magnified view of an element 1 in group 11 of FIG. 15, at 10 μM of a scale bar. FIG. 17 shows a magnified view of an element 1 in group 11 when a normal beam is irradiated, at 10 μM of a scale bar. FIG. 18 shows an intensity profile in element 1 in group 11 of FIG. 16. Further, FIG. 19 shows a synthetic spectrum by FPM at a log scale measured according to a test example of the present disclosure.

In the test example of the present disclosure, used is a positive USAF-1951 resolution target coated with chromium in a quartz plate, consisting of group 4 through group 11. FIG. 7 Shows a high-resolution image intensity and a synthesized spectrum through the FPM reconstruction. FIG. 16 is a magnified view around the finest pattern. For comparison, FIG. 17 shows an image intensity in the same region when a normal beam is irradiated from an on-axis. FIG. 18 shows an intensity profile of element 1 in group 11 (488 nm period; 2,048 lp/mm), and it is clearly resolved in two perpendicular directions.

As shown in FIGS. 15 to 19, and particularly in FIG. 16, in conclusion, it is seen that a high resolution of about 250 nm or less is achieved through the reflective FPM using a parabolic mirror according to the embodiment of the present disclosure.

1. A reflective FPM using a parabolic mirror comprising:
a first illuminator having a first panel that is provided with numerous LED light sources and composed of a first LED array irradiating a plurality of first LED beams to a measurement object sequentially at different angles through an objective lens;
a second illuminator having a second panel that is provided with numerous LED light sources and composed of a second LED array irradiating a plurality of second LED beams to the measurement object sequentially at different angles, following irradiation from the first illuminator;
a parabolic mirror reflecting each of second beams generated from the second illuminator, allowing being incident on the measurement object;
a lens configured to collect a beam from the measurement object to which the first and second LED beams were irradiated; and
a photodetector receiving light from the lens and acquires images for each of a plurality of first and second beams.

2. The reflective FPM using a parabolic mirror of claim 1, wherein
the first panel is a plate shape,
the LED array is a ring shape, arranged at a center point of the first panel and spaced apart from each other at a predetermined distance in a circumferential direction with reference of the center point of the first panel, and the first ring-shaped LED array is arranged in plural numbers, spaced at a certain distance in a radius direction.

3. The reflective FPM using a parabolic mirror of claim 2, wherein
the second panel is a ring shape with a central hole,
the second LED array is a ring shape, spaced from each other at a predetermined distance in a circumferential direction with reference of a center point of the second panel, and the second ring-shaped LED array is arranged in plural numbers, spaced at a certain distance in a radius direction.

4. The reflective FPM using a parabolic mirror of claim 3, further comprising
an LED control portion controls that the first LED light source positioned at the center point of the first panel irradiates a beam, and then starting with the light sources on the first LED array having a smaller radius, the light sources irradiate beams sequentially, followed by controlling that starting with the light sources on the second LED array having a smaller radius, the light sources irradiate beams sequentially, and
the photodetector acquires images for the respective beams.

5. The reflective FPM using a parabolic mirror of claim 4, further comprising
an analysis unit that calculates a synthetic image having phase information of the measurement object by placing each of the images in a spectral domain and stitching.

6. The reflective FPM using a parabolic mirror of claim 1,
the first beam is irradiated from the first illuminator, passes through an optical system and reflected by a beam splitter, and then is incident on the measurement object through an objective lens.
